(19) United States
(12) Patent Application Publication
(10) Pub. No.: US 2003/0121835 A1
(43) Pub. Date: Jul. 3, 2003

(54) Apparatus for and method of sieving biocompatible adsorbent beaded polymers

(76) Inventors: Peter Quartararo, New York, NY (US); Robert Albright, Southampton, PA (US)

Correspondence Address: Ilya Zborovsky, 6 Schoolhouse Way, Dix Hills, NY, 11746, US

(21) Appl. No.: 10/029,863

(22) Filed: Dec. 31, 2001

(51) Int. Cl. B07B 1/00

(52) U.S. Cl. 209/262; 209/17

(57) ABSTRACT

For sieving biocompatible adsorbent beaded polymeric materials a column is filled with beads, a fluid is supplied into the column upwardly, a screening element located in the column between a bottom of the column and a top of the column so that beads below a predetermined threshold are displaced by the fluid flowing upwardly and through the screening element, while beads above the predetermined threshold are retained under the screening element, and another fluid is supplied downwardly so as to prevent clogging of said screening element and to agitate the polymeric beads in the column under the screening element.

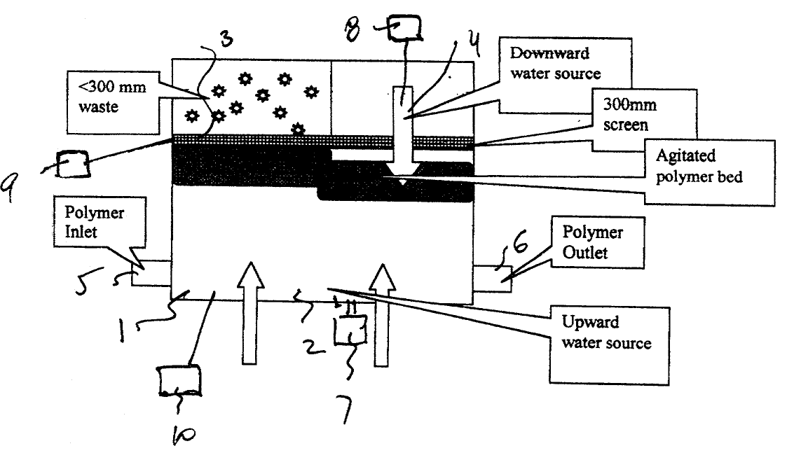

### BACKGROUND OF THE INVENTION

The present invention relates to an apparatus for and method of sieving biocompatible adsorbent beaded polymers.

Generally, there are two methods of manufacturing adsorbent polymer beads. The first system is jetting. This method can produce large quantities of beads in a very narrow size range. However, the equipment requires a large capital investment. The second, and more commonly used process involves a mechanical stirring apparatus, which creates axial mixing with in the vessel. The design of the mixing apparatus has a large affect on gaussian distribution of particle size obtained during a polymerization. For mechanical reasons, a portion of the polymer produced during a polymerization is usable due to its size. For example, particles less than 300 mm in size may clog the polymer beads causing unwanted back pressure within a column or device. Particles that are too large may not function well with regard to adsorptive capacity as a function of time. Therefore, it is often necessary to sieve the polymer to eliminate fine or small particles. It may also be necessary to exclude large particle.

Currently, several sieving methods are known in the industrial use.

Mechanical sieving is a method whereby a screen or mesh is employed. The screen or mesh has openings that are of a size sufficient to allow particles smaller than the openings to pass through the mesh while preventing larger particles from passing through. Mechanical sieving can be conducted wet or dry.

Wet sieving employs a fluid, typically water, to assist the sieving process. An amount of polymer is placed on top of a screen. Water is then flowed over the polymer and screen. The movement of water, with gravity, down through the screen carries the particles which are sufficiently small through the sieve leaving behind particles larger than the screen or mesh openings. For example, employing a 300 mm sieve would eliminate particles from the sample smaller than 300 mm and preserve particles greater than 300 mm. This method is problematic because the mesh tends to clog. Larger particles, retained by the mesh fill up the available openings and the mesh must be continually unclogged. Shaking, vibration and other mechanical methods can be employed to unclog the mesh. However, these methods can be unreliable and may damage the polymer. Maintaining sterility in an environment such as this is also extremely challenging.

Dry sieving is accomplished in the exact same way except that gravity, or inertia, are the only forces used to transport the particles through the sieve. Dry sieving can create a great deal of static electricity that can prevent sieving from being completed. There are several methods that can be employed to eliminate or prevent the static build up. Combining the polymer with talc (a mineral) is one method. However, this method is not viable when maintaining sterility is required.

Sieving is also performed in a column filled with a fluid. This method works well for maintaining sterility and cannot clog because it does not use a mesh or screen in order to size the beads. A bed of polymer is placed in a column filled with a fluid. Depending on the density of the polymer, alternative fluids can be used such as water, alcohol, or some mixture of the two. The fluid is accelerated contra-gravity with a linear flow rate of sufficient speed to expand the polymer bed. However, the linear flow rate cannot be so greater as to cause the polymer to flow to the top of the column and out the drain mechanism. Once the bed is expanded, at a constant linear flow rate, the polymer will separate according to size. Larger, heavier beads will collect toward the lower portion of the expanded bed. Smaller particles and fines will propagate and collect toward the top of the column. Once this is accomplished, the linear flow rate can be increased sufficiently in a manner that allows the unwanted particles to enter the drain mechanism at the top of the column. As this process continues, samples of the polymer are taken at the top of the expanded bed. When a certain predetermined percentage of the beads tested are of sufficient threshold size, what remains in the column is reported “sized” above that threshold size.

Although this method works, it is a slow and inexact process. Only a relatively small amount of polymer can be processed at a given time. This limitation is a function of the size of the column and the amount of fluid required to expand the bed. It is also very time consuming and easily allows particles below the threshold size to remain in the column.

### SUMMARY OF THE INVENTION

Accordingly, it is an object of the present invention to provide an apparatus for and a method of sieving biocompatible adsorbent beaded polymers, which avoid the disadvantages of the prior art and constitutes further improvements of the existing apparatuses and methods.

In keeping with these objects and with others which will become apparent hereinafter, one feature resides, briefly stated, in an apparatus for sieving biocompatible adsorbent beaded polymeric materials, comprising means forming a column for accommodating beads; means for supplying a fluid into said column to raise upwardly; a screening element located in said column between a bottom of said column and a top of said column so that beads below a predetermined threshold are displaced by the fluid flowing upwardly and through said screening element, while beads above the predetermined threshold are retained under said screening element; and means for supplying another fluid downwardly so as to prevent clogging of said screening element and to prevent clogging of said screening element and to agitate the beads in said column under said screening element.

It is a further feature of the present invention to provide a method for sieving biocompatible adsorbent beaded polymeric materials, comprising the steps of forming a column accommodating beads; supplying a fluid into said column upwardly; arranging a screening element in said column between a bottom of said column and a top of said column so that the beads below a predetermined threshold are displaced by the fluid flowing upwardly through said screening element, while beads above the predetermined threshold are retained under said screening element; and supplying another fluid downwardly so as to agitate the polymeric beads in said column under said screening element.

When the apparatus is designed and the method is performed in accordance with the present invention, efficient, low cost process is provided that maintains sterility of polymer by allowing for the batch processing of relatively large quantities of polymer.

The novel features which are considered as characteristic for the present invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

The single FIGURE of the drawings is a view schematically showing an apparatus for sieving biocompatible adsorbent polymers in accordance with the present invention.

### DESCRIPTION OF THE PREFERRED EMBODIMENTS

An apparatus for sieving biocompatible beaded adsorbent polymers has a column which is identified as a whole with reference numeral 1. The column 1 is filled with a medium, which is preferably sterile, for example with ultrapure water as identified with reference numeral 2. Beads of biocompatible beaded adsorbent polymer are supplied into the column. A sieving element 3 is arranged in the column between its bottom and top, such that the entire path through the column is dissected. The sieving element 3 can be formed as a mechanical sieve, a mesh, a screen, etc. When the sieving element 3 is installed in the column the only way for a particle to pass from the bottom of the column to the top of the column is through one of the openings in the sieving element.

The apparatus further has a fluid supply source which supplies a fluid, for example water from above downwardly, as identified with reference numeral 4.

Drawing reference numeral 5 identifies an inlet for polymeric beads for supplying the beads to be sieved, and reference numeral 6 identifies an outlet for the polymeric beads for discharging the beads after being sieved. Reference numeral 7 identifies a fluid source which supplies fluid into the column from below. Reference numeral 8 identifies means for transversely moving or rotating the fluid source 4, reference numeral 9 identifies means for rotating transversely moving or rotating the screening element 9, and reference numeral 10 identifies means for transversely moving or rotating the column 1. The transversely moving or rotating means can be formed as any known means, such as for example a motor with a corresponding transmission, etc.

In operation the fluid is supplied in the column 1 upwardly by the source 4, in direction of anti-gravity, so as to press the beads of the polymer up against the screening element 3. The flow rate of the fluid is sufficient to force the beads below a threshold size through the openings in the screening element 3. Sufficiently large beads are retained under the screening element 3 in the column 1. The source of fluid, such as pressurized water, identified with reference numeral 4 supplies the fluid in a counter current to the fluid which is supplied from the bottom of the column upwardly. The fluid supplied by the source 4 directs the fluid downwardly through at least a part of the area of the screening element 3, which is significantly less than 100%. In this way, the fluid jet supplied by the source 4 and directed downwardly causes the bed of the polymeric beads to turn over and to be agitated. The upward velocity of the fluid supplied from below again pushes the polymeric beads up against the screening element 3 so as to allow smaller particles to make there way to the screening element and penetrate the openings of the screening element.

Preferably the fluid which is supplied upwardly from the bottom of the column 1 to the screening element 3 covers the entire area of the screening element. In contrast, the downward jet of the fluid supplied by the source 4 can be constantly transversely displaced, preferably in a circular motion, so as to repeatedly cover the entire area of the screening element from above. This can be also accomplished by keeping the fluid source 4 stationary, and rotating the column 1 or rotating the screening element 3 within the column 1.

It will be understood that each of the elements described above, or two or more together, may also find a useful application in other types of constructions differing from the types described above.

While the invention has been illustrated and described as embodied in apparatus for and method of sieving by a compatible adsorbent polymers, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims.

1. A device for sieving biocompatible adsorbent beaded polymeric materials, comprising means forming a column for accommodating beads; means for supplying a fluid into said column upwardly; a screening element located in said column between a bottom of said column and a top of said column so that beads below a predetermined threshold of the polymeric material are displaced by the fluid flowing upwardly and through said screening element, while beads above the predetermined threshold are retained under said screening member; and means for supplying another fluid downwardly so as to prevent clogging of said screening element and to agitate the polymeric beads in said column under said screening element.

2. A device as defined in claim 1, wherein said means for supplying fluid upwardly is formed so that the fluid cover, an entire area of said screening element while said means for supplying the other fluid downwardly is formed so as to cover only a portion of the entire area of said screening element.

3. A device as defined in claim 1; and further comprising means for providing a relative movement between the fluids in a direction which is transverse to a vertical direction.

4. A device as defined in claim 3, wherein said means for providing the relative movement include means for turning said means for supplying the other fluid downwardly.

5. A device as defined in claim 4, wherein said means for providing a relative movement include means for rotating said column.

6. A device as defined in claim 4, wherein said means for providing a relative movement include means for rotating said screening member.

8. A method for sieving biocompatible adsorbent polymeric materials, comprising the steps of forming a column; supplying a fluid into said column upwardly; arranging a screening element located in said column between a bottom of said column and a top of said column so that beads below a predetermined threshold of the polymeric material are displaced by the fluid flowing upwardly and through said screening element, while beads above the predetermined threshold are retained under said screening element; and supplying another fluid downwardly so as to prevent clogging of said screening element and to agitate the polymeric beads in said column under said screening element.

9. A method as defined in claim 8, wherein said step of supplying fluid upwardly includes supplying the fluid so as to cover an entire area of said screening element while said step of supplying the other fluid downwardly includes supplying so as to cover only a portion of the entire area of said screening element.

10. A method as defined in claim 8; and further comprising the steps of providing a relative movement between the fluids in a direction which is transverse to a vertical direction.

11. A method as defined in claim 10, wherein said step of providing the relative movement includes rotating said further fluid downwardly.

12. A method as defined in claim 10, wherein said step of providing a relative movement include rotating said column.

13. A method as defined in claim 10, wherein said step of providing a relative movement include rotating said screening element.
